(19) United States
(12) Patent Application Publication
(10) Pub. No.: US 2013/0100135 A1
(43) Pub. Date: Apr. 25, 2013

(54) METHOD OF ESTIMATING DIFFUSION OF LIGHT

(71) Applicants: Cyril Delalandre, Montreull Le Gast (FR); Pascal Gautron, Rennes (FR); Jean-Eudes Marvie, Rennes (FR)

(72) Inventors: Cyril Delalandre, Montreull Le Gast (FR); Pascal Gautron, Rennes (FR); Jean-Eudes Marvie, Rennes (FR)

(73) Assignee: THOMSON LICENSING, Issy de Moulineaux (FR)

(21) Appl. No.: 13/807,494

(22) PCT Filed: Jun. 21, 2011
(86) PCT No.: PCT/EP2011/060373

§ 371 Date: Dec. 28, 2012

(30) Foreign Application Priority Data
Jul. 1, 2010 (EP) 10305720.4

(51) Int. Cl. G06T 15/50

(52) U.S. Cl. CPC G06T 15/50
USPC 345/426

(57) ABSTRACT

The invention relates to a method for estimating the quantity of light scattered by a heterogeneous participating media. In order to improve the display while minimizing the required calculation time, the method comprises steps for estimating projection coefficients in a function database using values representative of density for a set of points of said media situated along at least one emission direction of light by a light source, and for estimating of the quantity of light scattered by said media, according to at least one diffusion direction of the light, using said estimated projection coefficients.

### 1. DOMAIN OF THE INVENTION

The invention relates to the domain of synthetic image composition and more specifically to the domain of light diffusion simulation in a heterogeneous participating media. The invention is also understood in the context of special effects for a live composition.

### 2. PRIOR ART

According to the prior art, different methods exist for simulating the diffusion (scattering) of light in participating media such as for example fog, smoke, dust or clouds. Participating media correspond to media composed of particles in suspension that interact with the light modifying particularly the trajectory and intensity.

Participating media can be broken down into two groups, namely homogenous media such as water and heterogeneous media, such as smoke or clouds. In the case of homogenous participating media, it is possible to calculate analytically the attenuation of the light transmitted by a light source. In fact, due to their homogenous nature, these media have parameters such as the light absorption coefficient or the light scattering coefficient that are constant at any point of the media. Conversely, the light absorption and scattering properties vary from one point to another in a heterogeneous participating media. The calculations required to simulate the scattering of light in such a heterogeneous media are then very costly and it is thus not possible to calculate analytically and live the quantity of light scattered by a heterogeneous participating media. In addition, the media not being scattered (that is to say the diffusion of the medium being anisotropic), the quantity of light scattered by the media also varies according to the scattering direction of the light, that is to say the direction in which a person views the media. Calculations estimating the quantity of light scattered must then be reiterated for each observation direction of the media by a person in order to obtain a realistic display of the media.

To produce the live display of heterogeneous participating media, some methods perform the pre-calculation of some parameters representative of the heterogeneous participating media. Though these methods are perfectly adapted for a studio use in post-production for example and provide a good quality display, these methods are not adapted in the context of live interactive conception and composition of a heterogeneous participating media. Such a method is described for example in patent application WO2009/003143 filed by Microsoft Corporation and published on Dec. 31, 2008. The purpose of the application WO2009/003143 is a live display application for a heterogeneous media and describes a solution using radial base functions. This solution cannot however be considered as a live display solution as some pre-processing must be applied offline to the participating media to be able to calculate projection coefficients representative of the media that will be used for image synthesis live calculations.

With the emergence of interactive simulation games and applications, notably in three dimensions (3D), the need is being felt for live simulation methods offering a realistic display of heterogeneous participating media.

### 3. SUMMARY OF THE INVENTION

The purpose of the invention is to overcome at least one of these disadvantages of the prior art.

More specifically, the purpose of the invention is to optimise the required calculation time to compose a realistic live display of the diffusion of light in a heterogeneous participating media.

The invention relates to a method for estimating the quantity of light scattered by a heterogeneous participating media, the method comprising steps for:
estimating projection coefficients in a function basis using values representative of density for a set of elements of the heterogeneous participating media situated along at least one light emission direction by a light source, and
estimating the quantity of light scattered by the heterogeneous participating media, according to at least one diffusion direction of the light, using estimated projection coefficients.

Advantageously, the elements of the heterogeneous participating media are points or particles.

According to a specific characteristic, the estimation of projection coefficients is independent of the wavelength of the light emitted by the light source.

According to a particular characteristic, the projection coefficients are estimated taking into account a predetermined scale factor Δ.

Advantageously, the projection coefficients are estimated using a ray-marching method, the heterogeneous participating media being composed of points.

According to a specific characteristic, the projection coefficients are estimated using a particle blending method, the heterogeneous participating media being composed of points.

Advantageously, the method comprises a step of estimating the values representative of the reduction of light intensity based on the estimated projection coefficients.

According to a particular characteristic, the estimation of the quantity of light scattered by the said media is carried out by discretization of the heterogeneous participating media along at least one diffusion direction.

According to another characteristic, the estimation of the quantity of light scattered by the heterogeneous participating media is carried out using a ray marching method.

Advantageously, the estimation of the quantity of light scattered by the heterogeneous participating media is carried out using a particle blending method.

According to another characteristic, the projection coefficients are stored in a projective texture.

### 4. LIST OF FIGURES

The invention will be better understood, and other specific features and advantages will emerge from reading the following description, the description making reference to the annexed drawings wherein:

FIG. 1 diagrammatically shows a heterogeneous participating media diffusing light, according to a particular embodiment of the invention,

FIG. 2 diagrammatically shows a method for estimation of the attenuation of light in a media of FIG. 1, according to a particular embodiment of the invention,

FIG. 3 diagrammatically shows a method for estimation of the quantity of light scattered by a media of FIG. 1, according to a particular embodiment of the invention,

FIG. 4 shows a device implementing a method for estimation of the quantity of light scattered, according to a particular embodiment of the invention,

FIG. 5 shows a method of estimation of the quantity of light scattered, according to a particular embodiment of the invention.

### 5. DETAILED DESCRIPTION OF THE EMBODIMENTS OF THE INVENTION

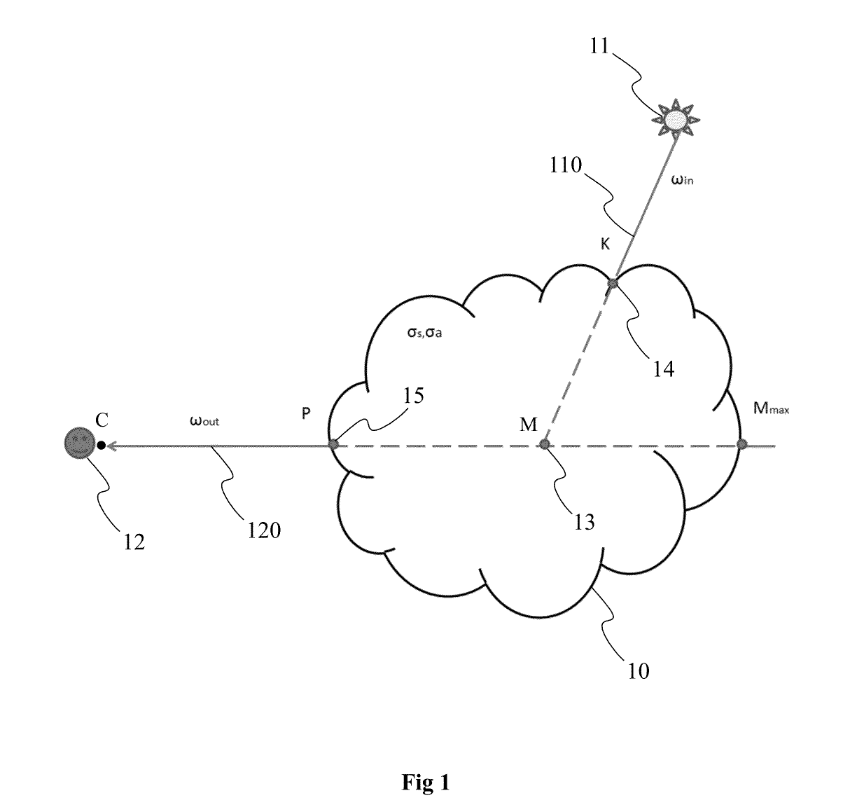

FIG. 1 shows a heterogeneous participating media 10, for example a cloud. A participating media is a media, composed of a multitude of particles in suspension, that absorbs, emits and/or diffuses light. In its simplest form, a participating media absorbs only light, for example the light received from a light source 11 such as the sun for example. This means that the light passing across the media 10 is attenuated, the attenuation depending of the density of the media. The media being heterogeneous, that is to say that the physical characteristics of the media, such as the density of particles composing it for example, vary from one point to another in the media. As the participating media is composed of small particles that interact with the light, the incident light, that is to say received from the light source 11 according to one direction ωᵢₙ 110, is not only absorbed but it is also scattered. In an isotropic diffusion participating media, the light is scattered uniformly in all directions. In an anisotropic diffusion participating media, such as the cloud 10 shown in FIG. 1, the light diffusion depends on the angle between the incidence direction ωᵢₙ 110 and the diffusion direction ωₒᵤₜ 120 of the light. The quantity of light scattered in an element (assimilated to a point or to a particle defined by a centre and a ray of influence, a particle advantageously grouping a set of points having the same properties) M 13 of the media 10 in the diffusion direction ωₒᵤₜ 120 is calculated using the following equation:

Q(M,ωₒᵤₜ)=D(M)·σₛ·p(M, ωₒᵤₜ,ωᵢₙ)·Lᵣᵢ(M,ωᵢₙ) (1)

The quantity of light scattered by an element M 13 of the media attaining the eye of the spectator 12 situated at a point C of space in the direction ωₒᵤₜ 120, that is to say the quantity of light scattered by the element M and attenuated by the media 10 on the trajectory M-P, the point P being situated at the intersection of the media 10 and the direction ωₒᵤₜ in the direction of the spectator 12, is then:

L_{P}(M,ωₒᵤₜ)=Q(M,ωₒᵤₜ)·exp∫_{P}^{M}−D(s)·σₜ·ds (2)

wherein:
σₛ is the diffusion coefficient of the media,
σₐ is the absorption coefficient of the media,
σₜ=σₛ+σₐ is the extinction coefficient of the media,
D(M) or D(s) is the density of the media at a given element, the density varying from one element to another as the media 10 is heterogeneous,
p (M,ωₒᵤₜ,ωᵢₙ) is i the phase function describing how the light coming from the incidence direction ωᵢₙ is scattered in the diffusion direction ωₒᵤₜ at the element M,
Lₙ(M,ωᵢₙ) is the reduced light intensity at the element M coming from the incidence direction ωᵢₙ 110 and represents the quantity of incident light arriving at the element M after attenuation due to the trajectory of the light in the media 10 on the segment K-M, K being the intersection point between the media 10 and the incidence ray ωᵢₙ 110, and its value is:

exp∫_{M}^{K}-σₜ(s)ds (3)

with σₜ(s)=σₜ·D(s)
exp∫_{P}^{M}-D(s)σₜds represents the attenuation of scattered light due to the absorption and diffusion along the path from P 15 to M 13.

Equation 2 enables the quantity of light scattered by an element M and attaining the eye of a spectator 12 situated on the direction ωₒᵤₜ to be calculated. To calculate the quantity of light received by a spectator looking in the direction ωₒᵤₜ , the sum of all the contributions of the set of elements of the media located on the axis ωₒᵤₜ must be calculated, that is to say the elements located on the segment P-Mₘₐₓ, P and Mₘₐₓ being the two intersection points between the media 10 and the direction ωₒᵤₜ 120. The total scattered light arriving at P 15 from the direction ωₒᵤₜ 120 due to simple diffusion is thus:

L(P,ωₒᵤₜ)=∫_{P}^{Mmax}Lₚ(M,ωₒᵤₜ)dM (4)

In this case, it is considered that the light following the trajectory C-P is not attenuated.

This total scattered light is obtained by integration of contributions from all the elements situated between P and Mₘₐₓ on a ray having ωₒᵤₜ as direction. Such an integral equation cannot be resolved analytically in general and even less so for a live estimation of the quantity of light scattered. The integral is evaluated digitally using the method known as ray-marching. In this method, the integration domain is discretized into a multitude of intervals of size oₘ and the following equation is obtained:

L(P,ωₒᵤₜ )≈Σ_{P}^{Mmax}Lₚ(M,ωₒᵤₜ )δ_{M} (5)

Advantageously, the heterogeneous participating media 10 is a three-dimensional element, shown in two dimensions in FIG. 1 for reasons of clarity.

Advantageously, the heterogeneous participating media 10 is formed from a multitude of points, a density value being associated with each point. Density values are advantageously stored in a texture known as density texture.

According to a variant, the heterogeneous participating media 10 is formed (and represented by) a plurality of particles, a particle being assimilated with a sphere characterized by its centre and a ray of influence. A particle groups together several points with identical properties (e.g. density). Alternatively, a density value is associated with each particle.

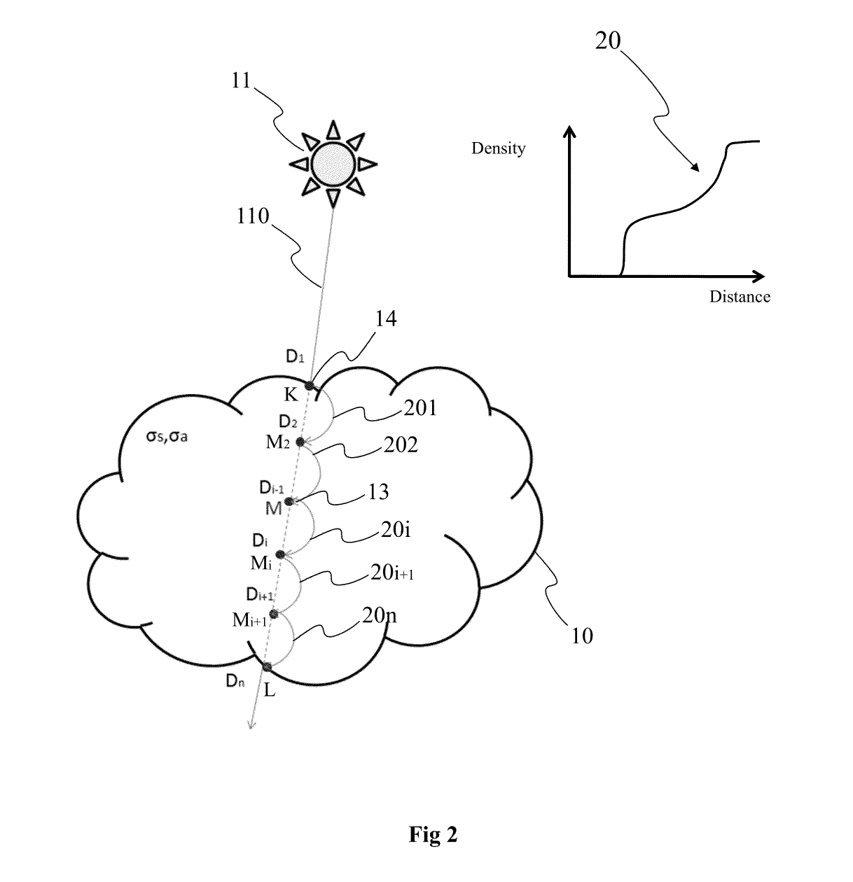

FIG. 2 shows a method for estimation of the attenuation of the light from a light source 11 in the heterogeneous participating media 10, and more specifically the application of the ray marching method to estimate the attenuation of the light in the media 10, according to a particular embodiment of the invention. As has been described with respect to FIG. 1, the scattered light at a point M 13 by the media 10 is a composition of the light attenuation received by the media 10 from a light source 11 and the diffusion of this quantity of attenuated light received by the media 10. Initially, with respect to FIG. 2, the term of equation 1 representative of the attenuation of the light received from the light source 11 in the media 10 is estimated. The term representative of the attenuation of the simple diffusion at a point M of the media 10 is shown by the following equation, equivalent to equation 3:

Att_{L}(M)=exp∫_{K}^{M}-σₜ(s)ds (6)

where Att_{L}(M) is the attenuation of the light intensity at the point M 13 and represents the quantity of incident light arriving at the point M after attenuation,
D(s) is the density of the media,
σₜ is the extinction coefficient of the media, corresponding to the sum of the diffusion coefficient of the media a and the absorption coefficient of the media σₐ (σₜ=σₛ+σₐ).
Advantageously, σₜ(s)=σₜ.D(s), which means that it is the density that varies from one point to another in the media 10. According to a variant, the density is constant from one point to another and it is the extinction coefficient which varies from one point to another or from one particle to another.

To simplify and accelerate the calculations required to estimate the attenuation of the light intensity at the point M 13, the values representative of the density D (s) are projected along the incidence ray corresponding to the intersection between the incidence direction ωₒᵤₜ 110 and the media 10, for example by using the inverse DCT (Discrete Cosine Transform) function. As a reminder, each function f(x) (e.g the function representative of density) of a functional space can be represented as a linear combination of base functions:

f(x)=Σⱼ₌₀^{N}cⱼBⱼ(x) (7)

wherein cⱼ is the j^{th} coefficient of the base function Bⱼ defined by:

cⱼ≈Σᵢ₌₀^{N}f(xᵢ).Bⱼ(xᵢ) (8)

Taking as an example the DCT base function “Discrete Cosine Transform”, the following formula is available to estimate the j^{th} projection coefficient Cⱼ:

$${C}_{j} = {α}_{j} {\sum }_{i = 0}^{N} f ( {x}_{i} ) \cdot cos ( \frac{π}{N} i ( j + 0.5 ) ) \\ with : \\ {α}_{j} = \{ \frac{\sqrt{2}}{2} si j = 0 ; \frac{\sqrt{2}}{N} sinon \} \qquad Equation 9$$

It is then possible to reconstruct the function f(x) by using the inverse DCT function, namely:

$$f ( x ) = {\sum }_{j = 0}^{N} {α}_{j} {c}_{j} \cdot cos ( \frac{π}{N} x ( j + 0.5 ) ) \qquad Equation 10$$

Based on equation 6 and projecting values representative of the function σₜ(s) (which is equivalent to projecting the density values D(s)) along the incidence ray corresponding to the intersection between the incidence direction ωᵢₙ 110 and the media 10 using the inverse DCT function, the following is obtained:

$${\int }_{K}^{M} - {σ}_{t} ( s ) d s = {\int }_{K}^{M} {\sum }_{j = 0}^{N} {α}_{j} {c}_{j} \cdot cos ( \frac{π}{N} x ( j + 0.5 ) ) d x \qquad Equation 11$$

This equation 11 can be rewritten as follows:

$${\int }_{K}^{M} - {σ}_{t} ( s ) d s = {\sum }_{j = 0}^{N} {α}_{j} {c}_{j} {\int }_{K}^{M} cos ( \frac{π}{N} x ( j + 0.5 ) ) d x \qquad Equation 12$$

One advantage of this equation 12 is that it can be solved simply in the following way:

$${\int }_{K}^{M} cos ( \frac{π}{N} x ( j + 0.5 ) ) d x = \frac{N}{πj} ( sin \frac{π j}{2 N} \cdot cos \frac{π jx}{2 N} ) + cos \frac{π j}{2 N} \cdot sin \frac{π jx}{2 N} - sin \frac{π j}{2 N} \qquad Equation 13$$

And the term cⱼ is obtained by transforming the function σₜD(x) into DCT using a ray-marching method for example:

$${c}_{j} = {α}_{j} {\sum }_{i = 0}^{N} {σ}_{t} ( {x}_{i} ) \cdot cos ( \frac{π}{N} i ( j + 0.5 ) ) \qquad Equation 14$$

In fact, to estimate the j^{th} projection coefficient cⱼ at point M, the integration domain situated on the incidence direction 110 considered between the entry point K 14 of the light ray 110 in the media 10 and a point considered of the media 10 is discretized into a series of intervals 201, 202, 20i, 20i+1, 20n of size δₛ. Moreover, the density also varies from one point to another, the density being equal to D₁ in K and to Dᵢ according to the position of the point Mᵢ on the incidence ray ωᵢₙ 110. To calculate the j^{th} coefficient cⱼ at the point M for example based on equation 14, the sum of contributions of the points K, M and M2 to which density values D₁, D₂, Dᵢ₋are associated is calculated.
The variable xi of equation 14 corresponds to the distance between K 14 and the considered point along the considered incidence ray (e.g. M₂ or M when calculating cⱼ at point M).

The set of projection coefficients of the base functions thus calculated is stored in a projective texture, such a projective texture being comparable with a shadow map. The calculated coefficients are representative of the density (or the variation of density) along the emission direction associated with each element (called texel) of the projective texture. A graphical representation of the density variation according to a given direction 110 is made possible using these base function coefficients, as shown in 20 in FIG. 2.

The use of projection coefficients representative of density enables rapid calculation of the light attenuation at the point M 13 along the incidence direction 110, the light attenuation being calculated using equation 6:

Att_{L}(M)=exp∫_{K}^{M}-σₜ(s)ds (6)

By applying the ray-marching method to estimate the light attenuation at point M, the following equation is obtained:

Att_{L}(M)≈Π_{K}^{M}exp^{-σ}^{ₜ₍ₛ₎}^{δ}^{ₛ} (15)

or Att_{L}(M)≈expΣ_{K}^{M}-σₜ(s)δₛ (16)

The following equation is obtained from equations 11 and 16:

$${Att}_{L} ( M ) \approx exp ( {\sum }_{j = 0}^{N} {α}_{j} {c}_{j} {\int }_{K}^{M} cos ( \frac{π}{N} x ( j + 0.5 ) ) d x ) \qquad Equation 17$$

The estimation of Att_{L}(M) is fast because the projection coefficients Cj were previously estimated (and advantageously stored in a projective texture). It is then easy to find Lₙ(M) since Lₙ(M) is equal to the product of Att_{L}(M) and the quantity of light emitted by the light source 11 along the direction of light emission. Lₙ(M) is thus equivalent to Att_{L}(M) up to a factor.

The extinction coefficient of the media _{Qt} being dependent on the wavelength of the light emitted by the light source, it may be necessary to calculate a set of base function coefficients for each elementary component of the light, for example the R, G and B (Red, Green, Blue) components, each R, G and B component having a specific wavelength or the R, G, B and Y (Red, Green, Blue, Yellow) components. To avoid these numerous calculations and thus accelerate the processing necessary for the estimation of these coefficients and also to minimize the memory space required for storage of these base function coefficients, the estimation of base function coefficients is carried out independently of the wavelength of the light emitted by the light source, according to an advantageous variant of the invention. To do this, the term _{Qt} is taken from equation 7 that becomes:

Att′_{L}(M)≈Π_{K}^{M6l exp}^{-D(s)δ}^{ₛ} (18)

where Att_{L}(M)=(Att′_{L}(M))^{σ}^{ₜ}

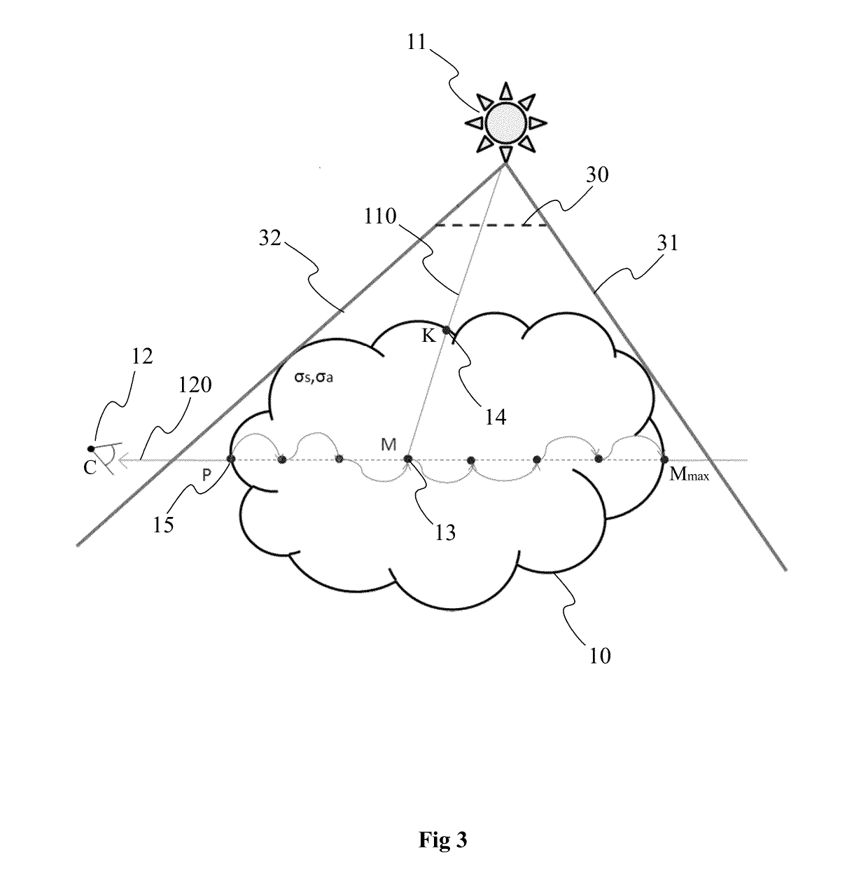

The coefficient σₜ from equation 18 is taken into account during the estimation of the quantity of light emitted by the point M as will be explained with respect to FIG. 3.

According to another variant, a scale factor Δ is introduced in equation 15 or in equation 18. This scale factor Δ advantageously enables the influence of the density to be reduced in equations 15 or 18 and particularly enables the reduction, even suppression, of ringing artifacts or Gibbs effects, due to the reduced intensity transformation of the light in the functional space, for example in the Fourier space. The equations 15 and 18 then become according to this variant:

$$\begin{matrix}{Att}_{L}^{Δ} ( M ) \approx {\prod }_{K}^{M} {exp}^{- \frac{D ( s )}{Δ} {σ}_{t} {δ}_{s}} \\ and \\ {Att}_{L} ( M ) = {( {Att}_{L}^{Δ} ( M ) )}^{Δ} & Equation 19 \\ {Att}_{L}^{′Δ} ( M ) \approx {\prod }_{K}^{M} {exp}^{- \frac{D ( s )}{Δ} {δ}_{s}} \\ and \\ {Att}_{L}^{′} ( M ) = {( {Att}_{L}^{′Δ} ( M ) )}^{Δ} & Equation 20\end{matrix}$$

The scale factor Δ is advantageously configurable and determined by the user and is for example equal to twice the maximum density of the media, or more than twice the maximum density, for example three or four times the density maximum.

Advantageously, the operations described above are reiterated for each lighting direction (or incidence direction or light ray) emanating from the light source 11 and crossing the media 10. For each light ray, the base function coefficients representative of the density during the traversing of the media are stored in the projective texture. The projective texture then comprises all the projection coefficients representative of density in the media.

FIG. 3 shows a method for estimation of simple diffusion of light in the heterogeneous participating media 10, more specifically the application of the ray marching method to estimate this simple diffusion in the media 10, and more generally a method for estimation of diffusion of light via the media 10 using base function coefficients calculated previously, according to a particular embodiment of the invention. To calculate the simple diffusion of light in the media 10, the ray marching method is implemented according to a non-restrictive embodiment of the invention. Initially, the light attenuation factor of a point M 13 of the media 10 corresponding to the attenuation of the light on the trajectory going from M 13 to P 15, is estimated via the following equation:

att(M)=exp∫_{P}^{M}-D(s)σₜ^{_{ds}} (21)

The density D(s) of an element (that is to say the point Mᵢ considered, the position of the point Mᵢ going from P to M) of the line segment [PM] varying as the media is heterogeneous.

The media being heterogeneous, the equation 10 is very costly in calculating power and thus cannot be calculated analytically. To overcome this problem, a ray marching P-M is carried out according to the direction ωₒᵤₜ and after discretization of the segment P-M into a multitude of elements δₛ the following is obtained:

att(M)≈Π_{P}^{M}exp^{-D(s)σ}^{ₜ}^{δ}^{ₛ} (22)

Using projection coefficients representative of density over the incident trajectory of the light from the light source 11 (estimated via equation 14 described with respect to FIG. 2) and stored in a projective texture 30 and from equation 17, it is possible to estimate the overall attenuation of the light at a point M as it is received by a spectator 12 (that is to say composition of the light attenuation in the media 10 according to ωᵢₙ 110 and according to ωₒᵤₜ 120) analytically, the resources in terms of calculating power required being very much less with respect to those required for an analytic resolution of integral form equations. It is then possible to estimate the quantity of light emitted by a point 13 of the media and received by a spectator 12 looking in the direction ωₒᵤₜ . The following is thus obtained:

$$\begin{matrix}{L}_{P} ( M , {ω}_{out} ) \approx {σ}_{s} ( M ) \cdot p ( M , {ω}_{out} , {ω}_{in} ) \cdot {Att}_{L} ( M ) \cdot {\prod }_{P}^{M} {exp}^{- D ( s ) {σ}_{t} {δ}_{s}} \\ or & Equation 23 \\ {L}_{P} ( M , {ω}_{out} ) \approx {σ}_{s} ( M ) \cdot p ( M , {ω}_{out} , {ω}_{in} ) \cdot {\sum }_{j = 0}^{{N}_{c}} {c}_{j} {B}_{j} ( x ) \cdot {\prod }_{P}^{M} {exp}^{- D ( s ) {σ}_{t} {δ}_{s}} \\ or & Equation 24 \\ {L}_{P} ( M , {ω}_{out} ) \approx {σ}_{s} ( M ) \cdot p ( M , {ω}_{out} , {ω}_{in} ) \cdot exp ( {\sum }_{j = 0}^{N} {α}_{j} {c}_{j} {\int }_{K}^{M} cos ( \frac{π}{N} x ( j + 0.5 ) ) d x ) \cdot {\prod }_{P}^{M} {exp}^{- D ( s ) {σ}_{t} {δ}_{s}} & Equation 25\end{matrix}$$

wherein x represents the position of the point M considered on the segment [KL] or in an equivalent manner the distance from K to M along the direction ωᵢₙ 110 and N_{c} represents the number of projection coefficients. Equation 12 represents the quantity of light emitted by a point M and received by a spectator. The term

$${\int }_{K}^{M} cos ( \frac{π}{N} x ( j + 0.5 ) ) d x$$

is calculated using equation 13.

To obtain the total quantity of light received by a spectator situated at a point C looking in the direction ωₒᵤₜ 120, it suffices to add the sum of quantities of elementary light emitted by the set of points Mᵢ going from P to Mₘₐₓ The following equation is obtained:

Q(C,ωₒᵤₜ)≈Σ_{P}^{M}^{ₘₐₓ}Lₚ(M,ωₒᵤₜ)δ_{M} (26)

To obtain the total quantity of light scattered by the media 10 and received by the spectator 12, the estimations described above are reiterated for all directions leaving the user and crossing the media 10. The sum of light quantities received by the spectator according to each observation direction provides the quantity of light received from the media 10 by the spectator 12.

According to a variant according to which the coefficients Cj are calculated independently of the extinction coefficient σₜ, equation 12 becomes:

Lₚ(M,ωₒᵤₜ)≈σₛ(M).p(M,ωₒᵤₜ,ωᵢₙ).(Σⱼ₌₀^{N}^{_{c}}cⱼBⱼ(x))^{σ}^{ₜ}.Π_{P}^{M}exp^{-D(s)σ}^{ₜ}^{δ}^{ₛ} (27

According to the variant according to which a scale factor is introduced into the calculation of the attenuation of light in M, equation 12 becomes:

L_{P}(M,ωₒᵤₜ)≈σₛ(M).p(M,ωₒᵤₜ,ωᵢₙ).(Σⱼ₌₀^{N}^{_{c}}cⱼBⱼ(x))^{σ}^{ₜ}^{Δ}.Π_{P}^{M}exp^{-D(s)σ}^{ₜ}^{δ}^{ₛ} (28)

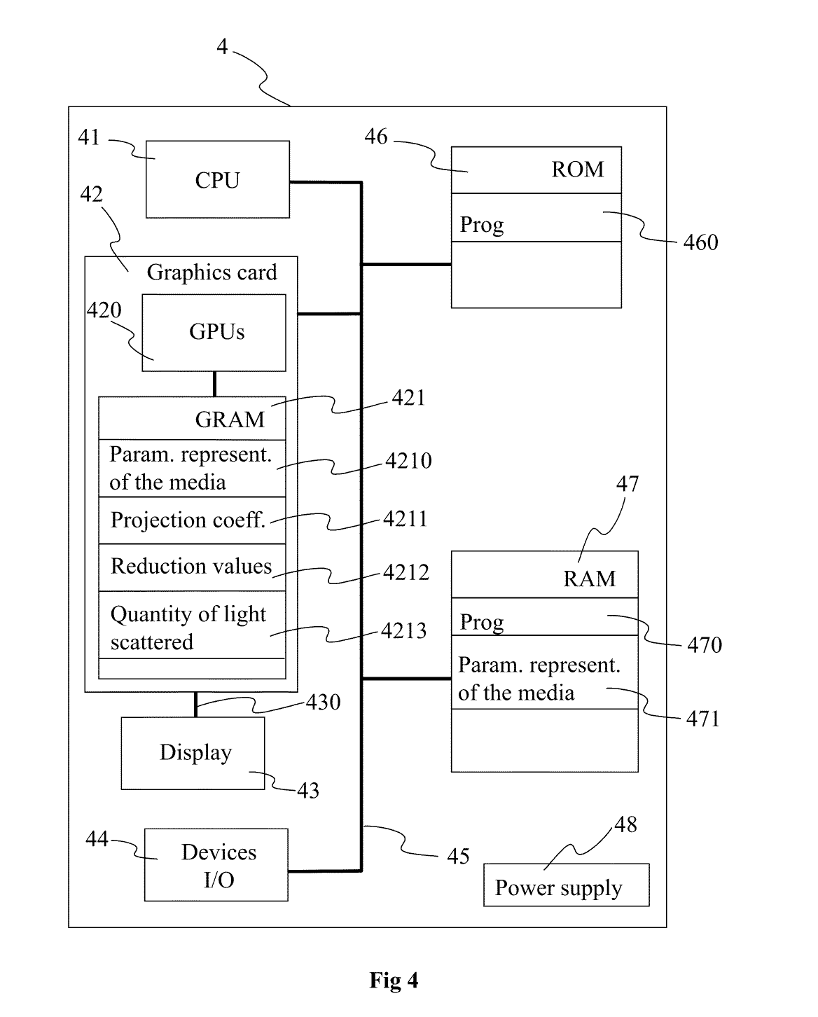

FIG. 4 diagrammatically shows a hardware embodiment of a device 4 adapted for the estimation of the quantity of light scattered by a heterogeneous participating media 10. The device 4 corresponding for example to a personal computer PC, a laptop or a games console.

The device 4 comprises the following elements, connected to each other by a bus 45 of addresses and data that also transports a clock signal:
a microprocessor 41 (or CPU);
a graphics card 42 comprising:
several Graphics Processing Units (or GPUs) 420;
a Graphical Random Access Memory (GRAM) 421;
a non-volatile memory of ROM type (“Read Only Memory”) 46;
a Random Access Memory (RAM) 47;
one or several I/O (Input/Output) devices 44 such as for example a keyboard, a mouse, a webcam, and
a power supply 48.

The device 4 also comprises a display device 43 of display screen type directly connected to the graphics card 42 to display notably the synthesised images calculated and composed in the graphics card, for example live. The use of a dedicated bus to connect the display device 43 to the graphics card 42 offers the advantage of having much greater data transmission bitrates and thus reducing the latency time for the display of images composed by the graphics card. According to a variant, the display device is external to the device 4. The device 4, for example the graphics card, comprises a connector adapted to transmit a display signal to an external display means such as for example an LCD or plasma screen or a video-projector.

It is noted that the word “register” used in the description of memories 42, 46 and 47 designates in each of the memories mentioned, both a memory zone of low capacity (some binary data) as well as a memory zone of large capacity (enabling a whole program to be stored or all or part of the data representative of data calculated or to be displayed).

When switched-on, the microprocessor 41 loads and executes the instructions of the program contained in the RAM 47.

The random access memory 47 notably comprises:
in a register 430, the operating program of the microprocessor 41 responsible for switching on the device 4;
parameters 471 representative of the heterogeneous participating media 10 (for example parameters of density, of light absorption coefficients, of light diffusion coefficients, of the scale factor Δ).

The algorithms implementing the steps of the method specific to the invention and described hereafter are stored in the memory GRAM 47 of the graphics card 42 associated with the device 4 implementing these steps. When switched on and once the parameters 470 representative of the environment are loaded into the RAM 47, the graphic processors 420 of the graphics card 42 load these parameters into the GRAM 421 and execute the instructions of these algorithms in the form of microprograms of “shader” type using HLSL (High Level Shader Language) language or GLSL (OpenGL Shading Language) for example.

The random access memory GRAM 421 notably comprises:
in a register 4210, the parameters representative of the media 10,
projection coefficients 4211 representative of the density at each point of the media 10 or associated with each particle of the media 10;
reduction in light intensity values 4212 for all or part of the points of the media 10;
values 4213 representative of the quantity of light scattered by the media 10 according to one or several observation directions.

According to a variant, a part of the RAM 47 is assigned by the CPU 41 for storage of the coefficients 4211 and values 4212 to 4213 if the memory storage space available in GRAM 421 is insufficient. This variant however causes greater latency time in the composition of an image comprising a representation of the media 10 composed from microprograms contained in the GPUs as the data must be transmitted from the graphics card to the random access memory 47 passing by the bus 45 for which the transmission capacities are generally inferior to those available in the graphics card for transmission of data from the GPUs to the GRAM and vice-versa.

According to another variant, the power supply 48 is external to the device 4.

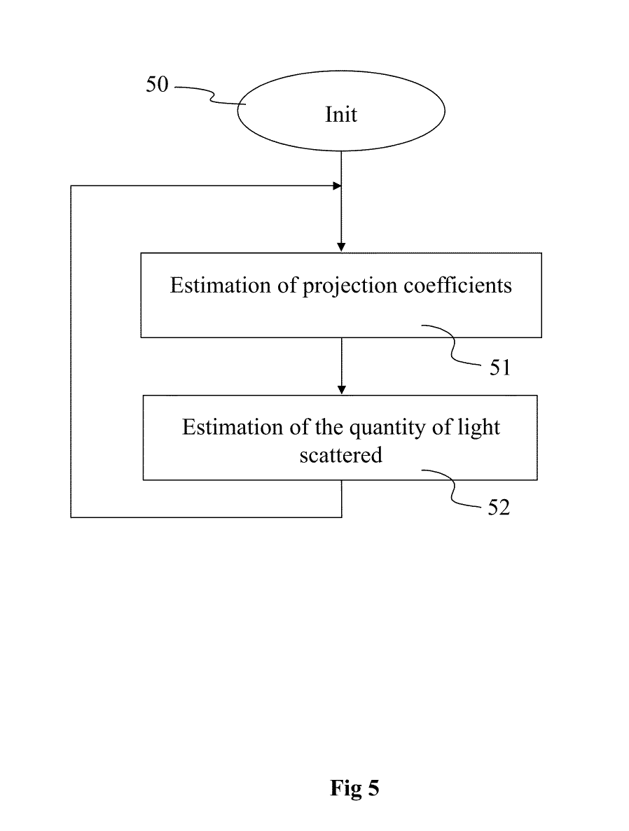

FIG. 5 shows a method for estimation of diffusion of light in a heterogeneous participating media implemented in a device 4, according to a first non-restrictive particularly advantageous embodiment of the invention.

During an initialisation step 50, the different parameters of the device 4 are updated. In particular, the parameters representative of the heterogeneous participating media 10 are initialised in any way.

Then, during a step 51, the projection coefficients of a base function are estimated, these projection coefficients being representative of the density whose values vary in the heterogeneous participating media 10. To do this, the function σₜ(s) representative of the density variations in the media 10 is projected and illustrated in a functional space of the base functions, for example using a Fourier transform or a Discrete Cosine Transform. From the density values associated with the elements (that is to say to the points or particles) of the media 10, a set of projection coefficients is calculated for an emission direction of the light 110, or more precisely for the line segment corresponding to the intersection of a light ray 110, coming from a light source 11, with the media 10. The line segment is advantageously spatially divided into a plurality of elementary pieces of the same length or different lengths and the projection coefficients representative of density are calculated for one point of each elementary piece of the segment. Advantageously, the method used to discretize the line segment and to estimate the projection coefficients is the method called ray-marching algorithm. For a point M 13 of the line segment, the associated projection coefficients are obtained by totalling the values depending on the density associated with each point situated between the intersection point K 14 of the media 10 and of the incidence ray 110 and considered point M as well as the distance between the intersection point K 14 and the point corresponding to the discretization of this piece of segment. Then a value representative of the reduction in light intensity at the point M 13 is calculated based on estimated projection coefficients. In the same way, a value representative of reduction in light intensity is calculated for each discretized point of the media 10 along the ray 110 based on associated projection coefficients.

According to a variant corresponding to the case where the media 10 is represented by a plurality of particles, each particle being characterized by a centre and an influence ray, a density value being associated with each particle, projection coefficients are estimated for a given particle of the segment [KL] using a method called particle blending. According to this method, values dependent on the density associated with the particles located between the intersection point K and the considered particle, and dependent on the distance between the particles located between K and the particle considered are added to one another. One advantage offered by this method is that the order in which the values dependent on density are taken has no impact on the result of the estimate of the projection coefficients, the performance of this estimate also being possible directly by the graphics card. A value representative of reduction in light intensity is thus advantageously calculated from estimated projection coefficients of incidence and advantageously for each particle of the incidence ray segment 110 included in the media 10.

According to another particularly advantageous variant, the projection coefficients representative of the density are estimated for each point of the media 10 or any particle of the media 10. The estimated projection coefficients are recorded and stored in a projective texture 30. Thus, a storage space of the projective texture is allocated for storing projection coefficients estimated for each incident light ray from the light source 11. There is as much storage space in the projective texture 30 as there are light rays coming from the source 11 and crossing the media 10. The projective texture advantageously comprises all projection coefficients of the media 10, that is to say a set of projection coefficients for each point or particle of the media 10. Such storage of projection coefficients offers the advantage of accelerating the calculations for estimating the quantity of light scattered by the media 10 and perceived by a spectator, the projection coefficients representative of density being available at all times and immediately for use in equations for estimating the reduction in light intensity values.

Then, during a step 52, the quantity of light scattered by the media 10 according to an emission direction 120 is estimated using projection coefficients estimated previously. To do this the line segment corresponding to the intersection of the emission direction 120 with the media 120, that is to say the segment [PMₘₐₓ] is spatially discretized into a multitude of points or elementary parts representative of this segment. For each point of this segment (respectively each elementary piece), equation 24 is applied using the projection coefficients previously estimated. According to a variant, the ray-marching method is implemented to estimate the reduction in light intensity between a point of the considered segment and the point P 15 situated on the periphery of the media 10 in the emission direction 120. The use of projection coefficients representative of the density according to an incident light ray simplifies the calculations to be carried out while providing a realistic estimate of the reduction in light intensity in a heterogeneous media. No pre-calculation is then required to carry out the display of the diffusion of light in a heterogeneous participating media, authorising the live display of such media in interactive applications of video game type for example in which the user is led to move virtually in a space comprising one or several heterogeneous participating media.

According to a variant corresponding to the case where the media 10 is represented by a plurality of particles, the estimation of the quantity of light scattered by said media is carried out using a particle blending method. According to this variant, the total quantity of light received by a spectator situated at a point C looking in the direction ωₒᵤₜ 120 is equal to the sum of quantities of elementary light emitted by the set of particles located on the trajectory ωₒᵤₜ between P to Mₘₐₓ. This variant presents the advantage of being able to sum the quantities of light emitted by the particles in any order and not necessarily progressing from P to Mₘₐₓ by summing the values of quantities of light emitted in that order. The order of consideration of the quantities of light emitted by each particle is arbitrary and is advantageously supported directly by the rendering pipeline of the graphics card.

Advantageously, the quantity of light scattered by the media 10 is estimated for several emission directions. By performing the sum of these quantities of light estimated for a plurality of emission directions, a total quantity of light scattered by the media 10 and perceived by a spectator observing the media 10 is obtained.

Steps 51 and 52 are advantageously reiterated as a spectator 12 moves around the media 10, the image forming the display of the media 10 being recomposed for each elementary displacement of the spectator 12 around the media 10.

Naturally, the invention is not limited to the previously described embodiments.

In particular, the invention is not limited to a method for estimation of the quantity of light scattered by a heterogeneous participating media but also extends to any device implementing this method and notably any devices comprising at least one GPU. The implementation of equations described with respect to FIGS. 1 to 3 for the estimation of coefficients of projection, of reduction of light intensity in the incidence and emission directions, of the quantity of light scattered is also not limited to an implementation in shader type microprograms but also extends to an implementation in any program type, for example programs that can be executed in a CPU type microprocessor.

Advantageously, the base functions used for the estimation of projection coefficients are Discrete Cosine Transform functions. According to a variant, the base functions used are standard Fourier functions or Legendre polynomials or Tchebyshev polynomials. For example, the diffusion method implemented in a device comprising a Xeon® microprocessor with a 3.6 GHz rate nVidia geforce GTX280 graphics card enables the display to be composed of 20 images per second live for a heterogeneous participating media of cloud type composed of 4096 spheres. The use of the invention is not limited to a live utilisation but also extends to any other utilisation, for example for processing known as post-production processing in a recording studio for the display of synthesis images for example. The implementation of the invention in post-production offers the advantage of providing an excellent visual display in terms of realism notably while reducing the required calculation time.

The invention also relates to a method for composition of a video image, in two dimensions or in three dimensions, for which the quantity of light scattered by a heterogeneous participating media is calculated and the information representative of the light that results is used for the displaying of pixels of the image, each pixel corresponding to an observation direction according to an observation direction ωₒᵤₜ. The calculated light value for displaying by each of the pixels of the image is re-calculated to adapt to the different viewpoints of the spectator.

The present invention can be used in video games applications for example, whether by programs that can be executed in a PC, laptop computer or in specialised games consoles producing and displaying live images. The device 5 described with respect to FIG. 5 is advantageously equipped with interaction means such as a keyboard and/or joystick, other modes for introduction of commands such as for example vocal recognition being also possible.

1. Method for estimation of the quantity of light scattered by a heterogeneous participating media, wherein the method comprises steps for:
estimation of projection coefficients in a function basis using values representative of density for a set of elements of said media that are situated along at least one emission direction of light by a light source, and
estimation of the quantity of light scattered by said media, according to at least one diffusion direction of the light, using said estimated projection coefficients.

2. Method according to claim 1, wherein the elements of the heterogeneous participating medium are points or particles.

3. Method according to claim 1, wherein the estimation of said projection coefficients is independent of the wavelength of the light emitted by the light source.

4. Method according to claim 1, wherein the projection coefficients are estimated taking into account a predetermined scale factor Δ, the density of tzaid medium being divided by said scale factor for the estimation of projection coefficients.

5. Method according to claim 1, wherein the projection coefficients are estimated using a ray-marching method, the heterogeneous participating media being composed of points.

6. Method according to claim 1, wherein the heterogeneous participating medium is composed of particles and the projection coefficients are estimated by summing the values associated with the particles that lie along the at least one emission direction of light and that are dependent ort densities associated with said particles and the distances separating said particles from the intersection point between the heterogeneous participating medium and said at least one emission direction of light.

7. Method according to claim 1, wherein it comprises a step of estimation of the values representative of the reduction in light intensity from estimated projection coefficients.

8. Method according to claim 1, wherein said estimation of the quantity of light scattered by said heterogeneous participating media is carried out by discretization of said media along the at least one diffusion direction.

9. Method according to claim 1, wherein said estimation of the quantity of light scattered by said heterogeneous participating media is carried out using the ray-marching algorithm method.

10. Method according to claim 1, wherein the heterogeneous participating media is composed of particles and said estimation of the quantity of light scattered by said heterogeneous participating media is carried out by summing the quantities of elementary light emitted by a set of particles situated along at least one diffusion direction of light.

11. Method according to claim 1, wherein said projection coefficients are stored in a projective texture.

12. Method according to claim 6, wherein the order of consideration of said values associated with said particles located along at least one emission direction of the light is any order.

13. Method according to claim 10, wherein the order of consideration of said quantities of associated elementary light emitted by said set of particles is any order.

14. Device configured for the estimation of the quantity of light scattered by a heterogeneous participating media, wherein the device comprises at least one processor configured for:
estimating projection coefficients in a function database using values representative of density for a set of elements of the said media that are situated along at least one emission direction of light by a light source, and
estimating the quantity of light scattered by said media, according to at least one diffusion direction of the light, using said estimated projection coefficients.

15. Computer program product, wherein it comprises instructions of program code for executing the steps of the method according to claim 1, when said program is executed on a computer.
